(19) United States
(12) Patent Application Publication
(10) Pub. No.: US 2014/0344371 A1
(43) Pub. Date: Nov. 20, 2014

(54) COMMUNICATIONS DEVICE, SYSTEM, AND METHOD FOR THOSE LACKING TECHNICAL KNOWLEDGE

(71) Applicant: Ean Schiller, Christiansburg, VA (US)

(72) Inventor: Ean Schiller, Christiansburg, VA (US)

(21) Appl. No.: 13/895,579

(22) Filed: May 16, 2013

(51) Int. Cl. H04L 12/58

(52) U.S. Cl. CPC H04L 51/18
USPC 709/206

(57) ABSTRACT

The present invention relates to a communications device, system, and method for sending and receiving electronic messages (such as emails, texts, etc.) without the sender of the message typing or directly interacting with (e.g., knowingly operating) a computer. The device comprises means for receiving an electronic message, means for converting said electronic message to a physical message, means for converting a physical message to an electronic message; and means for connecting to a network and transmitting and receiving said electronic messages to and from a remote computing device. The device sends and receives electronic messages to a contact of a user of the device through a remote message server connected to a network. The communications device, system, and method have a high level of usability for those lacking technical knowledge.

### BACKGROUND OF THE INVENTION

1. Field of the Invention

The present invention relates to a communication device and system for sending and receiving electronic messages (such as emails, texts, etc.) that can be used without the need for typing or using a computer.

2. Description of the Related Art

The fast pace of change in communication technologies is making it harder for some people to communicate. For the elderly, disabled, and anyone who is not technologically savvy, the constantly changing norms and interfaces of communication tools can be difficult to keep up with. Perhaps they know how to use a landline telephone but have trouble with touch screen devices. Maybe they know which buttons to click and in which order, to log onto a website today; but tomorrow, after the site updates and the buttons move, they get lost. Perhaps they simply do not use computers at all, or email, or Twitter, Facebook®, Instagram, etc.

At the same time that most of society adopts the newest technologies, traditional modes of communication decline. Pay telephones have mostly disappeared. The US Postal Service is closing offices. Fax machines are increasingly rare. For younger generations, these changes are hardly noticed because their communications are predominantly by digital means; but, for a significant number of people who do not use computers, staying in touch with friends and family is becoming increasingly difficult.

Consider the scenario where Grandmother has some hearing loss. She can converse in person but has trouble hearing what is said on the telephone. She likes getting letters, but with email, text messages and the rest, not many people take time to write letters anymore. Since she does not use a computer, she misses the Tweets, status updates, and shared photos that keep other people informed about the goings on in their friend's lives. She is getting left behind.

To catch up, Grandmother could adopt the computer. She would first have to pick out and buy a computer. She would have to set it up. She would have to subscribe to internet service, and get the modem installed, and get the computer to log into a network through the modem. She would need to learn to use the computer, and the mouse and keyboard. Being able to type would be helpful. There would be anti-virus software to buy and to setup. There would be email and social media sites to sign up for and to learn how to use. There would be phishing scams to avoid, and software updates to figure out. For people in Grandmother's situation, these are each daunting tasks and perhaps almost impossible to perform collectively.

Thus, there is a need for simpler ways to communicate that do not require computer skills. As with most significant problems, there have been prior efforts to solve this issue. Facsimile (fax) machines, for example, allow a sender to transmit arbitrary document content over a telephone or network line to a receiver where the document content gets printed out onto paper. Fax machines have been known since at least 1969 when Reese et. al. disclosed their “Facsimile Transceiver” (U.S. Pat. No. 3,469,027), the disclosure of which is incorporated by reference herein in its entirety. Since that disclosure, many variations and improvements have also been disclosed. With the fax, it is possible to insert handwritten correspondence into one machine and have that correspondence print out at a remote machine. So, for persons who do not type and want to share non-verbal communication, the fax machine could be an option.

There are several problems with the fax solution. The first is that to exchange faxes, both sender and receiver generally need to have fax machines. To receive faxes, those machines need to be active and connected to a non-busy telephone line. Faxes sent to busy lines generally do not go through, so to minimize the risk of failures and missed messages, fax machines are usually connected to telephone lines that are separate from those normally used for voice calls. Subscribing to extra telephone lines for fax machines is expensive and can be cost prohibitive. Configuring wiring and jacks for multiple telephone lines can also be challenging, especially in residential settings where multiple telephone lines might not have been setup during construction. Furthermore, because having fax machines for personal use is relatively rare, even if a sender did have the machine and infrastructure for sending handwritten notes by fax, the pool of receivers is small, and shrinking.

Another problem with fax machines is that traditionally they have not been easy to use. The sender must dial the telephone number of the receiver and insert the document to be sent, in the correct sequence. Sometimes there are phone number formatting or access issues, such as for international calls. The document must be inserted into the machine in the correct orientation such that the machine's optical scanner can record the document content. Once the fax machine has accepted the document, the sender generally waits to verify that the fax was sent and received properly. If the sending machine gets no answer or a busy signal from the receiving machine, the transmission often fails and the sender must try again. The sender also needs to watch out for misdialed numbers, paper jams, and issues with running out of ink or toner. Sometimes there are settings to adjust related to how fast the document gets sent, what image quality is used, how the return receipt is formatted, etc. For persons who have trouble navigating technology, a fax machine can still be a challenge. Accordingly, it would be desirable to have a simpler means for sending and receiving messages that also does not require the sender and receiver to have specialized hardware and infrastructure.

Another potential solution is a fax-to-email service, like those disclosed by Henry et. al. (U.S. Pat. No. 7,079,275, U.S. Pat. No. 8,023,132, U.S. Pat. No. 8,195,540, and others), which disclosures are hereby incorporated by reference herein in their entireties. This approach involves the sender writing their message onto a special form which is comprised of a message area along with standardized heading fields for hand printing the email address of the receiver. The sender uses a standard fax machine to send the form to the telephone number of the service. When the service receives the fax, it uses optical character recognition (OCR) to extract the receiver email address from the standardized heading fields. The service then sends the image of the faxed message to the receiver email address. While a fax-to-email service solves part of the fax problem, where the receiver has to have a fax machine, because email messages are not usually delivered by fax, the sender still needs to have a fax machine and a telephone line and there is still the problem of usability. Sending an email by fax machine still entails all of the complexity of an ordinary fax transmission with the additional burden of having to laboriously hand print each character of the receiver's email address into the standardized heading fields. If the printing is not neat enough, the OCR will not be able to interpret the email address and the message will not reach the receiver. So, while fax-to-email has benefits, it is still too complex and error prone for the non technology savvy user.

It would be desirable to have a solution that also does not require the sender to have a telephone line or previously installed infrastructure, or need to dial a telephone number, or need to write neatly enough for OCR. Nalder (U.S. Pat. No. 6,614,931), the disclosure of which is hereby incorporated by reference herein in its entirety, discloses a messaging device comprising: a printer to print received messages along with an identifier for the message originator, an optical scanner to capture an image of the printed message after it has been annotated with a response message and handwritten keyword-based instructions, character recognition to detect the identifier and keywords and associated arguments, and a means for sending the captured image back to the message originator. With such a device, a message could be received and printed out onto a piece of paper along with a return address. The receiver could handwrite their reply onto the paper, mark the “reply input field”, and insert the paper back into the device to send the message back to its originator. While this concept has potential to simplify messaging, some problems remain. For example, non technology savvy users could have trouble getting the keywords and arguments formatted correctly, in the proper order, surrounded with the correct delimiters, spelled, sized, and written neatly enough for consistent OCR. When a receiver only wants to reply to the originator, they should not need to add any special keywords; however, they still must remember to mark a “reply input field”. Forgetting to mark the field is a clear opportunity for error.

The Nalder disclosure seems intended as a type of fax machine, for use with other fax machines. If such a machine were used to exchange email messages, when the originator receives a reply to their message it is not disclosed how the return address field for that reply would get populated, especially in cases where multiple people use the same messaging device. Consider the scenario where a messaging device serves a household and the message originator wants to ask two different members of the household about what they want for Christmas gifts. The originator could send two different messages, one addressed to each of the intended recipients. The messaging device would print out two messages, each pre-marked for return to the originator. After the recipients write out and send back their replies, the originator would get two messages apparently from the same address, possibly without other means for differentiating the senders. So while preprinting an identifier for the originator, onto message printouts, takes care of one message field, there would need to be preprinted identifiers for the recipients as well to allow for automatically populating the FROM addresses of reply messages. Thus, it would be desirable to have a solution capable of determining all of the necessary message inputs without requiring any instructions from the user, especially when performing simple message reply tasks.

In regards to encoding message inputs, instead of requiring hand entry, various potential solutions have been disclosed for other applications. For example, Burgess et. al. (U.S. Pat. No. 5,115,326), the disclosure of which is hereby incorporated by reference herein in its entirety, teaches a means for routing fax messages according to email addresses embedded as barcodes in a fax cover page. When a fax is sent with the encoded cover page it would be routed to the receiver's email. This could be helpful in that a barcode, instead of freehand OCR, directs the message; but, having a non-technical way to generate the barcode is unsolved. Also the approach would require receivers to have the special fax routing systems, which is not practical for personal use.

Sodeura et. al. (U.S. Pat. No. 7,710,589), the disclosure of which is hereby incorporated by reference herein in its entirety, discloses embedding address information in a symbol such as a QR Code (registered trademark) for the purposes of preventing mistransmission of documents; but, Sodeura's teachings do not address simplified communications.

Chapman (U.S. Pat. No. 4,106,060), the disclosure of which is hereby incorporated by reference herein in its entirety, discloses an electronic mail box comprised of, among others: an entry slot for receiving a letter to be transmitted electronically to a remote point, a means for converting the letter to electronic signals, a keyboard for entering address information, a means for recreating the letter content and ejecting the letter at a remote point. Chapman's invention relates to an alternative means for transmitting postal mail. It does not offer a simpler way for individuals to communicate.

Reich et. al. (U.S. Pat. No. 4,207,598), the disclosure of which is hereby incorporated by reference herein in its entirety, discloses a means for sending mail automatically wherein letters are put in a sending station uncovered and scanned with a television camera, the information is transmitted to storage in a telephone exchange, a numerical destination address written at a specific location is evaluated, letter information is transmitted to the destination where it is reproduced, and the letter is sealed and delivered. Although generally related to transferring messages electronically, U.S. Pat. No. 4,207,598 also does not address simplified individual communication.

Dattilo et. al. (U.S. Pat. No. 4,414,579), the disclosure of which is hereby incorporated by reference herein in its entirety, discloses a copier-printer employed in conjunction with an optical scanner and character recognition logic to transmit information contained in a document over a telephone or other communications line. Although generally related to electronic document transmission, copier-printers and optical character recognition are not practically accessible and simple enough to address the need for simple, person-to-person communication.

In U.S. Pat. No. 5,881,233, U.S. Pat. No. 6,124,939, and others, the disclosures of which are hereby incorporated by reference herein in their entireties, Toyoda et. al. discloses an electronic mail system connected to a network which is comprised of, among others: means for converting an image of a document into compressed data in an electronic-mail format, means for receiving an electronic-mail destination address, means for transmitting the data to the destination address, means for receiving the data, and means for printing out the image of the original document. Getting the destination address is said to involve recognizing the address in a given position of the image data. The teachings of Toyoda et. al. are practically directed at facsimile systems and do not provide actionable solutions to problems of communications tool complexity.

Ho et. al. (U.S. Pat. No. 6,061,502), the disclosure of which is hereby incorporated by reference herein in its entirety, discloses a communications device that transmits and receives information in accordance with both fax and email communication protocols. The device recognizes the destination as being a fax or email device and transmits the document accordingly. The device also allows the retrieval of email messages whereby a user enters an email address and presses a button to initiate the transmission and printing of the mail messages. While related to simpler communications, the disclosed device requires user input of a fax number or email address to send messages and user input of their own email address, and presumably authentication credentials, and a button press to retrieve messages. User inputs are error prone and inevitable mistakes will erode the effectiveness of the system and the benefits of the apparent simplifications. Furthermore, for non-technology savvy users, remembering to check the email, and remembering how to do so, would be expected to remain a burden.

Kasatani (U.S. Pat. No. 7,573,615), the disclosure of which is hereby incorporated by reference herein in its entirety, discloses a multifunction apparatus connected to a network that collects image data from an original document, extracts address, subject, and body information with OCR, forms an email from that address, subject and body information, and transmits the email while attaching the image of the original document to the body of the email. Again, OCR is not simple and robust enough, nor is operating the multifunction apparatus likely to be a practical communication solution for the non-technology savvy user.

Nale (U.S. Pat. No. 7,693,942), the disclosure of which is hereby incorporated by reference herein in its entirety, discloses a system for delivering postal service mail via email. The teaching discusses digitizing documents and ultimately transmitting them to email recipients but is intended for large quantity operation and does not otherwise inform a solution for simplified individual communications.

Hence, there remains a need for a simpler way for individuals to communicate that does not require: computer skills, telephone lines, special hardware to be used by the people with whom the user communicates, special inputs from the user when replying to messages, or the user to be able to write neatly enough for OCR.

### SUMMARY OF THE INVENTION

The present invention relates to a communications device, system, and method for sending and receiving electronic messages (such as emails, texts, etc.) without the sender of the message having to type a destination address or knowingly use a computer. The invention may include one or more devices connected by way of a network, such as the internet, to a remote message server.

In embodiments, the communications device can comprise: means for receiving an electronic message; means for converting said electronic message to a physical message; means for converting a physical message to an electronic message; and means for connecting to a network and transmitting and receiving said electronic messages to and from a remote computing device.

The means for receiving an electronic message may include: means for receiving electronic message data, such as email, from a remote message server, over a network; and means for extracting information from electronic message data.

According to embodiments, the communications device can be configured such that the information from said electronic message data includes a destination address and a source, or origination, address.

In embodiments, the communications system can be configured such that the remote message server comprises an inbound mailbox for the communications device. The inbound mailbox can be associated with one or more electronic addresses for users of the communications device. Likewise, the remote message server according to embodiments can comprise an outbound mailbox for the communications device.

Communication(s) systems can comprise or further comprise a reconciliation service connected to said network. Such communications systems can be configured such that the remote message server comprises an inbound mailbox for the reconciliation service. Likewise, in these embodiments, the inbound mailbox can be associated with an electronic address for the reconciliation service. Similarly, the remote message server of such embodiments can comprise an outbound mailbox for the reconciliation service. Alternatively or addition in such embodiments the outbound mailbox can be configured to deliver messages to a recipient.

The means for converting said electronic message to a physical message may include: means for encoding the destination and origination addresses, extracted from electronic message data, into a machine readable barcode, such as a QR code; means for assembling inbound messages in specific formats for printing onto physical media, from: a barcode encoded with the destination and/or origination addresses of an electronic message, and from information extracted from the electronic message data; means for printing inbound messages onto physical media; means for expelling physical media, printed with inbound messages, from the device for easy retrieval by the user; and means for causing the preceding operations to occur without user interaction with the device that is performing the assembling, or printing, or extracting, or expelling.

The means for converting a physical message to an electronic message may include: an opening for inputting physical media that has been annotated with message content; means for constraining the size and orientation of inputted physical media to the handling limits of the device; image capturing means for creating electronic image representations of the message content from physical media; means for guiding inputted physical media to the image capturing means; means for feeding physical media through the image capturing means; means for expelling physical media from the device after the message content has been captured; means for identifying and decoding barcodes in electronic image representations to obtain destination and origination addresses for electronic messages; means for correcting the orientation of electronic image representations; means for assembling electronic messages wherein electronic image representations of message content are embedded, attached, linked, or otherwise associated with the electronic message; means for assembling electronic messages wherein the destination and origination addresses are those decoded from electronic image representations; and means for causing the preceding operations to occur when physical media is inputted into the opening, without additional user intervention.

The means for connecting to a network and transmitting and receiving said electronic messages to and from a remote computing device may include: a network interface; and means for transmitting electronic messages through a remote message server to and from a destination addresses, over a network.

The communications device may further include: means for assembling status messages in specific formats for printing onto physical media, comprised of user relevant device or transmission status information, errors, or actionable notices, as applicable; means for assembling new message templates, pre-addressed templates, or other message templates, in specific formats for printing onto physical media, including a barcode encoded with the destination and origination addresses of an electronic message, for future annotation with message content, that when inputted into the device, will be transmitted to the same destination address as the electronic message; means for printing status messages and message templates onto physical media; and means for expelling physical media, printed with status messages and message templates, from the device for easy retrieval by the user.

The communications system comprises: a network; a communications device as described in this specification, such as that described above; and a remote message server for relaying said electronic message between said communications device and said remote computing device.

The remote message server may include: means for receiving, processing, and transmitting electronic messages to (inbound mailboxes for the) devices serving the users to which the electronic messages are addressed; and means for processing and transmitting electronic messages, originating from the devices, over appropriate network protocols, to their destination addresses.

In embodiments, the communications system further comprises a reconciliation means to process messages with handwritten or incomplete address information, or errors, wherein electronic messages are transferred for correction before being delivered to their intended destination addresses.

The communications method can comprise: handwriting message content onto physical media, wherein the physical media contains a destination address, whether or not in machine readable form; creating an electronic image representation of said message content; assembling an electronic message associated with said electronic image representation, wherein the destination address is decoded for example from said machine readable form; and transmitting said electronic message over a network through a remote message server to said destination address.

Such methods of embodiments of the invention can include methods wherein the physical media includes an origination address and the destination address is for a recipient of said electronic message, and/or wherein the destination address is for a reconciliation service which determines the origination address and a destination address for a recipient of said electronic message based on said message content, and/or wherein the reconciliation service transmits said electronic message to said recipient, and/or wherein said recipient receives said electronic message through a remote computing device connected to said network.

Methods according to embodiments of the invention include a method of communicating a message comprising: a. converting a first message disposed on physical media to an image; b. sending the image over an electronic network to a human for review; c. having the human identify a destination address for the first message; and d. having the human send the first message and a reply address to the destination address in a manner such that a second message is capable of being sent from the destination address to the reply address without inputting, deleting, or altering address information associated with the first or second message at a device associated with the destination address and without sending the second message to the human.

Alternatively or in addition, methods of communicating a message according to embodiments of the invention can comprise: automatically identifying an origination and destination address from an incoming message; printing the origination and destination addresses as one or more barcodes, with content from the incoming message, onto physical media; converting an outgoing message disposed on the physical media with the one or more barcodes to an electronic image; reading and using the one or more barcodes to determine a destination address for the outgoing message; and delivering the outgoing message to the destination address.

It should be understood within the context of this specification that when referring to “a” or “an” item, such as a destination address, an origination address, an initial, reply, incoming, or outgoing message, it is meant to include one or more. For example, when sending a message from an origination address, the message can be routed to one or more destination addresses.

Such methods can further comprise sending a third message from the reply address to the destination address without inputting the destination address for the third message or sending the third message to the human.

Methods of the invention can have a destination address in operable communication with a device capable of receiving an email or SMS text message. In preferred embodiments, such methods can have a destination address that is not an address for a fax machine.

As a device, the invention makes it easy for users to complete a fixed set of tasks—sending and receiving messages. This is in contrast to a standard desktop or laptop computer, which has more capabilities but is also more difficult to learn and to use. The device according to embodiments of the invention is intended to be plugged into a standard household electrical outlet. In embodiments, once plugged in, the device can be used without further set up steps, even including turning the device on. Because the device can have its own wireless internet service built-in, or use an existing wired or wireless network, it does not require special wiring, or a telephone line, or a pre-existing internet connection.

When a user joins a service that provides for messaging capabilities according to the invention, the user receives their own new electronic address (for example: an email address, phone number, or a handle for a social media application). The user distributes the electronic address to their family, friends and contacts. When someone sends a message to the user's address, the message content prints out automatically from the device's built-in printer, onto a piece of paper that feeds through an opening in the front of the device. Users retrieve the pieces of paper and read their inbound messages. Messages can be sent to the user's address by way of any number of communications means, including from email addresses, SMS text messages from phone numbers, fax messages from phone numbers associated with fax machines, for example.

To respond, the user hand writes a reply message into any blank space on that same piece of paper and feeds it back into the device, through a designated opening. Within the device, an optical scanner records what is written and printed on the paper, including a machine readable barcode containing the destination and origination addresses from the received message. An internal computer processor interprets the barcode, creates a new electronic message addressed to the sender of the received message, attaches an image of the scanned paper with the user's handwritten response, and sends the message through an internet connection. When the message arrives, it looks like a standard message of that type, but with an image attached showing the scan of the handwritten note.

All of the technical details involved with setting up, checking for, printing, creating, addressing, adding attachments to, and sending electronic messages are handled by the device, without user input. Users simply read inbound messages when they print out of the device, and hand write replies onto the same pieces of paper and feed them back into the device, when they want to send a reply. Users of the invention can exchange messages and readily communicate with people who use email, smartphones, and social media applications, even if they themselves do not know how to type, or do not have the technical knowledge to operate fax machines, email, smartphones, cell phones, tablets, laptop, or computers, or do not know how to use and maintain a computer.

In addition to simply responding to the inbound messages that they receive, users can also initiate messages. To initiate a message, a user fills out the new message template. New message templates print out from the device in response to certain events, such as at startup and immediately after a previous new message has been sent—so that new message templates are always on hand. New message templates can also be provided separately as individual pieces of paper or as sheets in preprinted message pads.

The new message template has fields for writing the destination address, the originating user's name or electronic address, and a message. Once the template is filled out, the user feeds it into the device. The device recognizes the barcode as being from a new message template and sends a scanned image of the completed template to a reconciliation service. Reconciliation converts the handwritten entries from the form into destination and origination addresses suitable for sending as an electronic message. Reconciliation uses human interpreters to identify the handwritten name, or electronic address, and intended destination address. From the name, or electronic address, and the ID of the device that sent the message, the service can identify the user's electronic address, as the origination address for the message. The service then sends a message to the intended destination address, from the identified origination address, along with the scanned image of the new message.

When a destination recipient gets the message, and replies, their reply goes directly to the origination address, the device user, without needing to pass back through the reconciliation service. By using human interpreters the reconciliation service is able to accept handwritten input without the constraints on formatting and neatness that can challenge non-technical users of OCR. So, by writing their reply on an inbound message, or by filling out a new message template, device users can send messages to anyone with a suitable electronic address.

The invention is especially useful for people who are elderly, disabled or not technologically savvy. It is a faster alternative to physical mail and a written alternative to the telephone. It is simpler to use than a fax machine and can reach a larger recipient pool, given the waning popularity of physical fax machines. For people who don't use computers or who suffer from hearing loss or speech impediments that make using a telephone difficult, it offers a more accessible mode of communication. It also helps the family and friends of the device user as they are able to exchange messages with the user via common digital means, even when the user does not otherwise use texts or email or social media websites.

Furthermore, some people get confused and frustrated by the constantly changing procedures and interfaces of modem communication systems. They do not like having to learn new technologies to complete the same tasks. This invention is an alternative to the ever changing landscape of communication technologies: emails, texts, tweets, Likes, etc. Users interact with a physical machine. The interface does not change from week to week. It is easy to use. It is always on and does not have screens or buttons, or can be configured to have very few screens or buttons. There are no logins or passwords to remember. If a person can read from and write to a piece of paper, then they already know what to do. Inbound messages print and dispense automatically. Sending messages is as easy as writing on paper and sticking the paper into a slot, a familiar procedure for anyone who has ever sent a physical letter through a postal mailbox.

There is also a rising appreciation for physical objects and nostalgia for older, simpler, slower forms of communication. Some people appreciate the physical processes of communication, the feel of an ink pen, the look and feel of the handwritten word. This invention is a bridge between physical and digital communication mediums: people who write letters can easily communicate with people who send emails, and vice versa. For users, it provides the feel and process of physical mail, but delivers it with the speed of electronic messaging.

### BRIEF DESCRIPTION OF THE DRAWINGS

FIGS. 1 and 2 are schematic diagrams which show an exemplary embodiment of a communications system according to the invention.

FIG. 3 is a schematic diagram showing a top, front, right side view of an exemplary embodiment of a communications device according to the invention.

FIG. 4 is a schematic diagram showing a top, front, right side view of an exemplary embodiment of a communications device according to the invention wherein a new message is inserted into an input slot.

FIG. 5 is a schematic diagram showing a top, front, right side view of an exemplary embodiment of a communications device according to the invention wherein a new message is fed into the device through the input slot for scanning.

FIG. 6 is a schematic diagram showing a top, front, right side view of an exemplary embodiment of a communications device according to the invention wherein a new message exits to an output tray after scanning.

FIG. 7 is a schematic diagram showing a top, front, right side view of an exemplary embodiment of a communications device according to the invention wherein an inbound message is received through an output slot.

FIG. 8 is a schematic diagram showing a top, front, right side view of an exemplary embodiment of a communications device according to the invention wherein the front panel is removed.

FIG. 9 is a schematic diagram showing a top front view of an exemplary embodiment of a communications device according to the invention wherein the front panel is removed.

FIG. 10 is a schematic diagram showing exemplary embodiments of a new message and a new message template according to the invention.

FIG. 11 is a schematic diagram showing an exemplary embodiment of an inbound message according to the invention.

FIG. 12 is a schematic diagram showing exemplary embodiments of a reply message and a pre-addressed template according to the invention.

FIG. 13 is a schematic diagram showing an exemplary embodiment of a reconciliation service customer list according to the invention.

FIG. 14 is a flowchart showing an exemplary embodiment of a process for receiving messages according to the invention.

FIG. 15 is a flowchart showing an exemplary embodiment of a process for sending messages according to the invention.

FIG. 16 is a flowchart showing an exemplary embodiment of a reconciliation service process according to the invention.

FIG. 17 is a flowchart showing an exemplary embodiment of inbound and outbound remote message server processes according to the invention.

FIG. 18 is a flowchart showing an exemplary embodiment of a process for communicating a message according to the invention.

### DETAILED DESCRIPTION OF EXEMPLARY EMBODIMENTS OF THE INVENTION

Reference will now be made to various figures showing exemplary embodiments of the invention. However, the embodiments described in the description and shown in the figures are illustrative only and are not intended to limit the scope of the invention, and changes may be made in the specific configurations and materials described in this specification and accompanying drawings that a person of ordinary skill in the art will recognize are within the scope and spirit of the invention.

As used herein, the terms “device” and “appliance” both refer to a communications device for sending and receiving electronic messages without the need for typing or knowingly interacting or instructing a computer according to the invention, and may be used interchangeably.

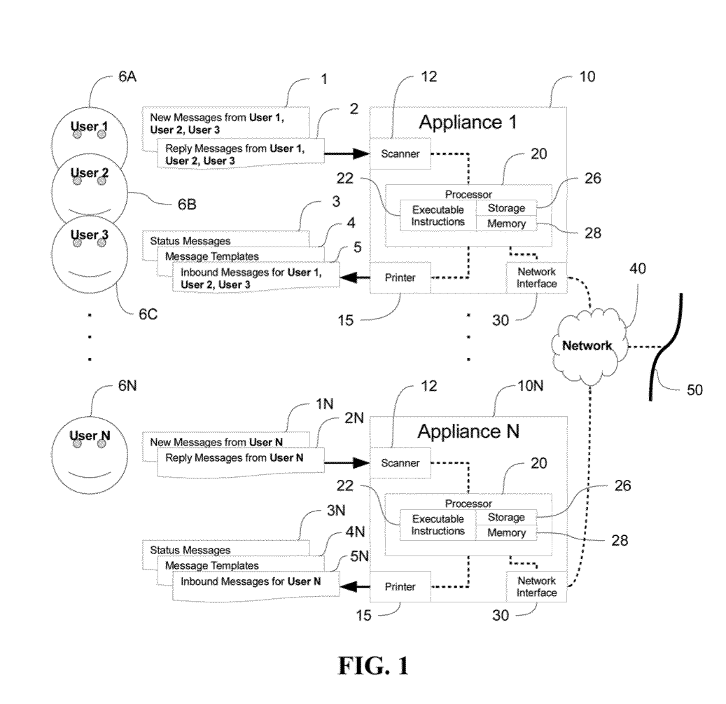

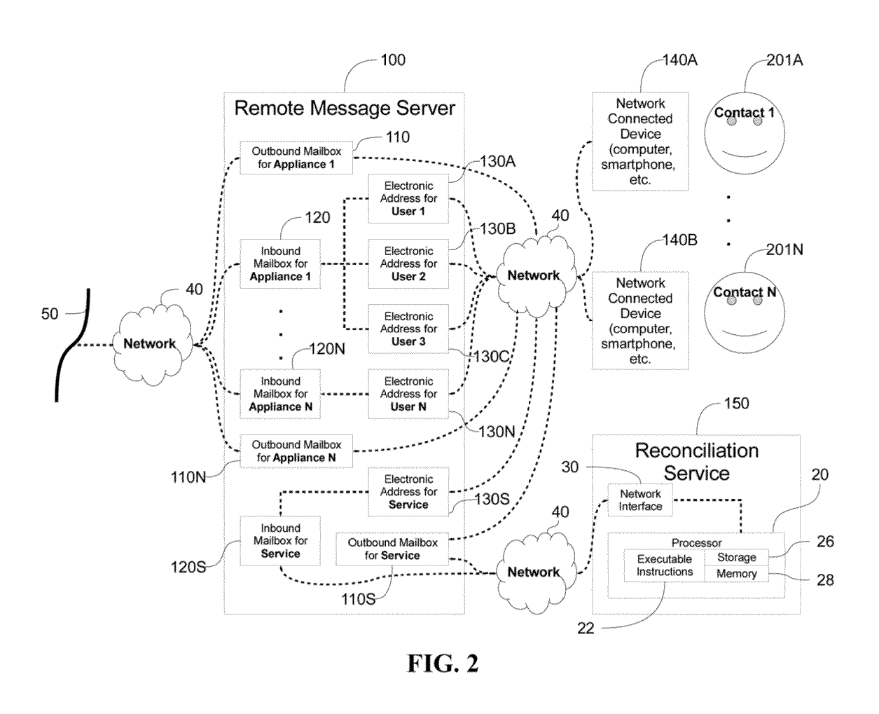

FIGS. 1 and 2 show an exemplary embodiment of a communications system of the invention as it relates to users sending and receiving messages to contacts through communications devices 10 connected to a network. Communications device 10 includes a scanner 12 and printer 15, in operable communication with a processor 20. The processor 20 can comprise a storage 26 and memory 28 as well as a set of executable instructions 22. The processor 20 is further connected to a network interface 30 which connects to a network 40 which may include a communications medium such as a fiber optic cable 50 or a wireless connection, or any configuration, means, and/or apparatus which is capable of providing for operable communication with the network. In using the device 10, one or more users 6A-6C may input documents such as a new message 1 or a reply message 2 to the scanner 12, and may receive various printouts including status messages 3, message templates 4, or inbound messages 5 from the printer 15. Multiple communications devices 10, such as ION, may be connected on the network 40. For example, an individual user 6N may input new messages 1N or reply messages 2N into the scanner 12 or receive status messages 3N, message templates 4N, or inbound messages 5N from the printer.

FIG. 2 further shows that messages from users 6A-6C, 6N are transmitted to contacts 201A, 201N through a network 40 and a remote message server 100. The remote message server 100 is connected to the network 40 and has both an outbound mailbox 110 and an inbound mailbox 120 that are specific for communications device 10. The inbound mailbox 120 is associated with electronic addresses 130A-130C which are specific for each of the users 6A-6C of the device 10. The remote message server 100 has multiple outbound 110N and inbound 120N mailboxes for different devices 100N as well as an electronic address 130N for each inbound mailbox 120N. The remote message server 100 further includes an inbound mailbox 120S and an outbound mailbox 110S for a reconciliation service 150. The inbound mailbox 120S is associated with an electronic address 130S for the reconciliation service 150. All outbound mailboxes 110A, 110N, 110S, and inbound mailboxes 120A, 120N, 120S, through their associated electronic addresses 130A, 130B, 130C, 130N, and 130S are connected to the network 40. Mailboxes for the reconciliation service 150 transmit communications through the network 40 to the reconciliation service 150 through a network interface 30, which connects to a processor 20 comprising storage 26, memory 28, and executable instructions 22. Mailboxes for communications devices 10, ION transmit communications through the network 40 to network connected devices 140A, 140B, such as a desktop computer, laptop, tablet, or smartphone that are specific for contacts 201A, 201N of the users 6A-6C, 6N.

Any number of users can be associated with any number of devices. Messages for a single user could be dispensed from multiple devices, as could messages for multiple users be dispensed from a single device. Users within communities or families could share devices to save cost. For example, a wing of a retirement community could have a device for multiple residents to share. Messages for each resident would dispense from the single device. Because message templates and replies contain barcodes encoding the destination and origination addresses, each resident could send messages from the same device too, without risk of a message from resident A going to a contact of resident B.

If a device fails, it can be replaced and all associated electronic addresses can be switched to the new device, without needing to issue new addresses or inform user contacts. If one user's electronic address receives too many junk or unsolicited messages, that electronic address can be disabled, without affecting other users of the device.

In a preferred embodiment the remote message server processes electronic messages sent by devices. Processing operations can include but are not limited to: formatting to conform to standards for the type of message being sent, and transmitting electronic messages over appropriate network protocols to destination addresses.

In a preferred embodiment the remote message server processes electronic messages sent to user electronic addresses. Processing operations can include but are not limited to: filtering to remove unsolicited and junk messages, formatting to aid subsequent assembly of messages for printing onto physical media, and forwarding electronic messages to corresponding inbound mailboxes for devices serving the users.

In a preferred embodiment, separate mailboxes on a remote message server are used for outbound mail and for inbound mail so that should junk or unsolicited messages be sent to the sending mailbox, instead of to the reply-to address as specified in outbound electronic messages originating from the device, then junk or unsolicited messages can be discarded and not processed by the device. Other embodiments could use the same mailbox on a remote message server to handle inbound and outbound mail.

In a preferred embodiment the remote message server is manageable remotely. The message server can reside on dedicated computational hardware or on a cloud computing platform comprised of multiple instances of computational hardware wherein processing, memory and storage resources are allotted as needed to multiple related or unrelated applications.

Specific communications systems according to embodiments of the invention can comprise: a. at least one first device having a communications address unique to the first device, wherein the first device is operably configured for converting a first message disposed on physical media to an image and operably configured for sending the image over an electronic network to a second device; b. at least one second device operably configured for a human to interpret a destination address from the image and to enable sending of the image to the destination address from the second device while appearing to be from the communications address associated with the user of the first device; and c. at least one third device operably configured for receiving the image from the second device and for sending a reply message to the first device without sending the reply message to the human.

Such communications systems can be configured such that the at least one first, second, and third devices are disposed remote from one another. In embodiments, the communications system can comprise a destination address that is in operable communication with a device capable of receiving an email or SMS text message. Likewise, systems of the invention can comprise a destination address that is not an address for a fax machine.

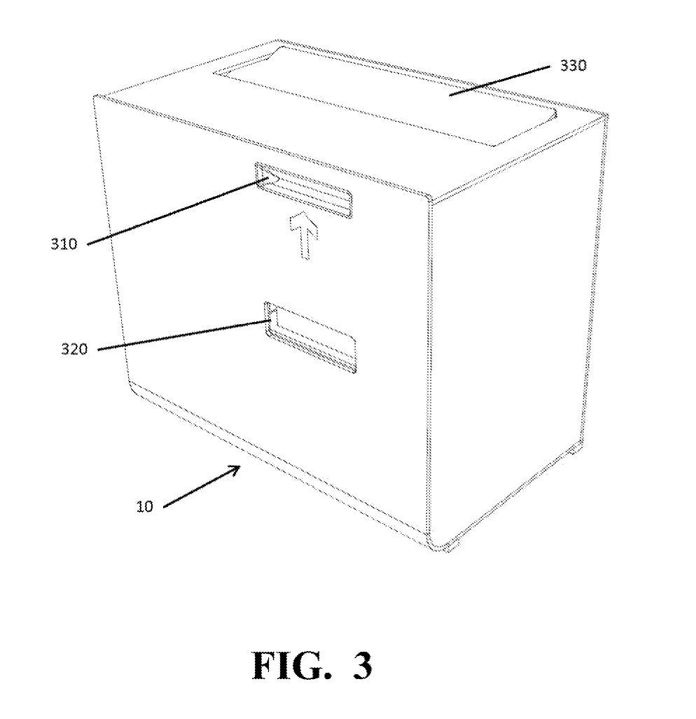

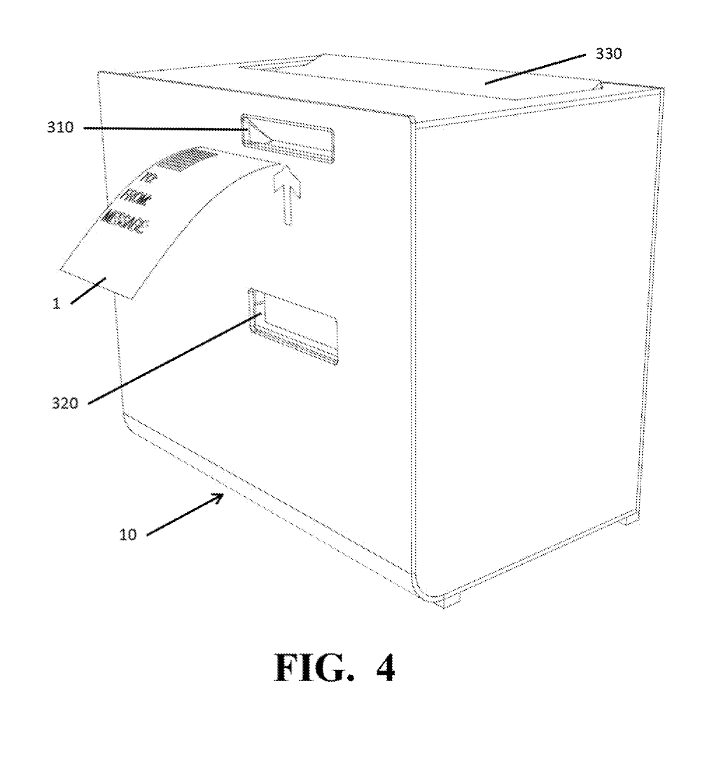

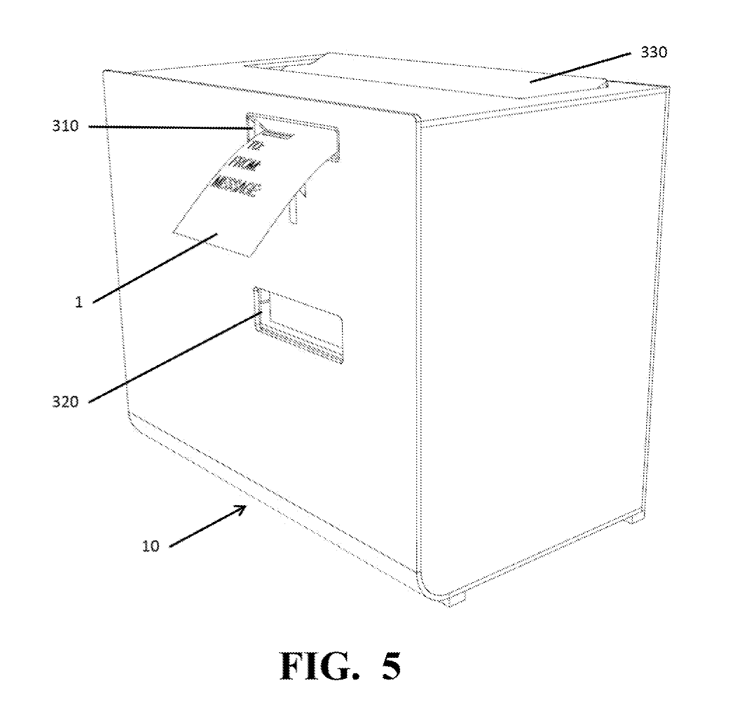

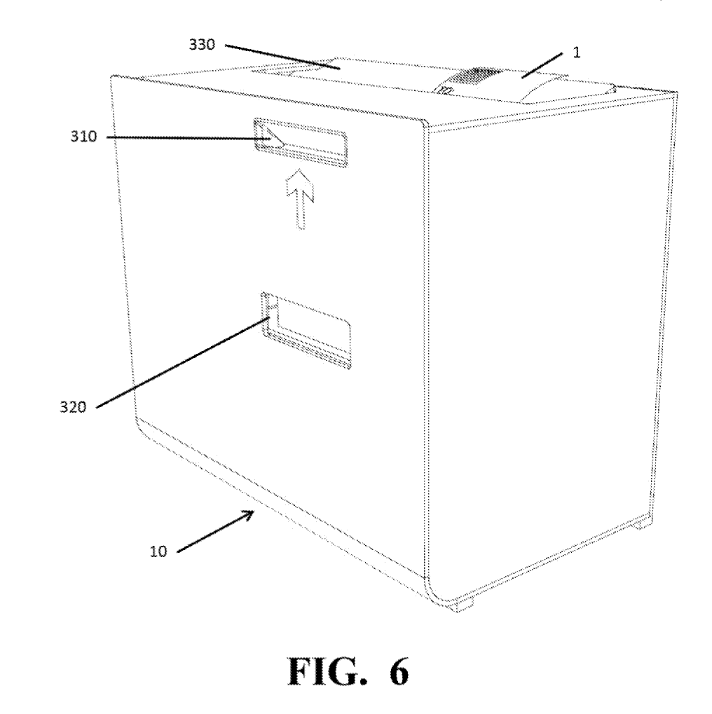

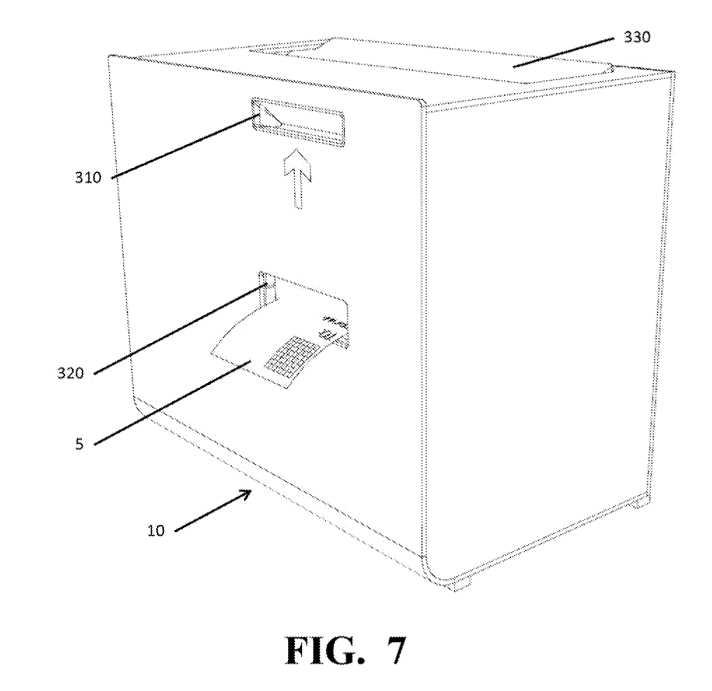

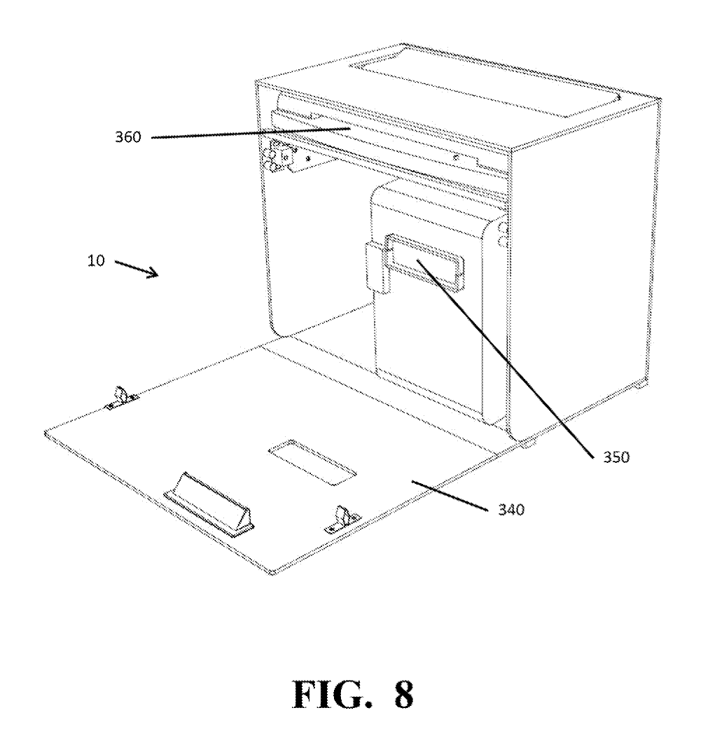

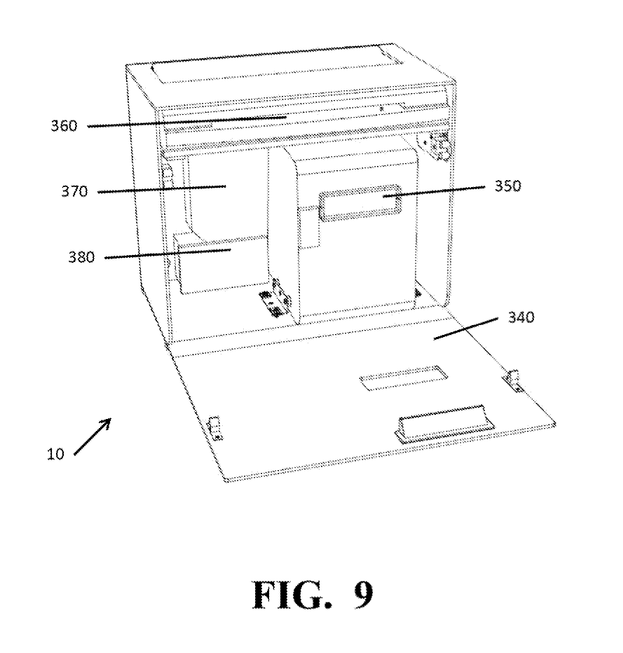

FIGS. 3-9 show an exemplary embodiment of a device 10 of the invention. Device 10 has an input slot 310 for feeding messages to be sent electronically to a contact 201 including new messages 1 and an output slot 320 for expelling printed messages received from a contact 201. FIGS. 4-6 show a process wherein new message 1 is inserted into input slot 310, where it is fed to a scanner component of the device 10 and then exits to an output tray 330 for the scanner. FIG. 7 shows an inbound message 5, received from contact 201, printed and expelled through output slot 320. FIGS. 8-9 show that front panel 340 opens for ease of access to the components of the device 10, which include a built-in printer 350, scanner 360, processor 370, with storage and memory, and network interface 380 (or for example an electrical box 380, or electrical box 380 comprising a network interface device).

In embodiments, included is a communications device comprising: an imaging module operably configured for converting an outgoing message disposed on physical media to an electronic image; a communications module comprising an origination address unique to the device, which module is operably configured for delivering the outgoing message to an intermediate address before being delivered to a destination address; a first processing module for identifying the destination address from an incoming message received as a reply to the outgoing message; a printer operably configured to print the destination address and the origination address in barcode form on a paper template of a second outgoing message; and a second processing module for reading and using the barcode to deliver the second outgoing message to the destination address from the origination address without delivering the second message through the intermediate address.

Alternatively or in addition, according to embodiments of the invention, the invention can include a communication device comprising: a first processing module for identifying an origination and destination address from an incoming message, a printer operably configured to print the origination and destination addresses as one or more barcodes, with content from the incoming message, onto physical media; an imaging module operably configured for converting an outgoing message disposed on the physical media with the one or more barcodes to an electronic image; a second processing module for reading and using the one or more barcodes to determine a destination address for the outgoing message; and a communications module operably configured for delivering the outgoing message to the destination address.

Such devices can be configured such that the imaging module is operably configured for inputting the physical media annotated with message content. Additionally, or alternatively, the communications device can have an imaging module that is operably configured for constraining size and orientation of the physical media.

The communications device of embodiments of the invention can comprise a printer operably configured to print the paper template for an outgoing message automatically in response to the incoming message.

Optionally, in devices and systems of embodiments of the invention, the communications device can be configured such that the intermediate address is associated with a reconciliation service comprising a human capable of processing electronic messages for delivery to their intended destination address.

Such systems and devices can be configured such that the reconciliation service is capable of determining the destination address from the electronic image.

The outgoing message in embodiments can comprise electronic image representations of message content embedded, attached, linked, or associated with the outgoing message.

The communications device of embodiments can further comprise executable instructions embedded in a computer readable medium for automating one or more operations performed by the imaging module, the communications module, the first or second processing module, or the printer. Embodiments of the invention include software comprising executable instruction embedded in a computer readable medium for performing one or more method steps according to the invention. The software can be used to operate one or more devices of the invention and/or one or more devices comprising part of a system of the invention.

Communications devices of embodiments of the invention can comprise a communications module operably configured with a network interface for connecting to an electronic network and for transmitting and receiving the outgoing, the incoming, and the second outgoing message to and from remote computing devices.

In a preferred embodiment the built-in printer 15, 350 uses thermal technology and roll paper, as is commonly used for printing receipts. Thermal printers do not require replacement ink. Roll paper allows printing messages to any length without regard for fixed sheet sizes, thereby minimizing waste as messages use only as much paper as they need. Paper feeding problems are also less common in roll printers than in sheet-fed printers. Other types of printers and papers are possible.

In a preferred embodiment the scanner 12, 360 is a duplex optical scanner, so it scans both sides of inserted pages at the same time. Scanning both sides of a page simultaneously means that users do not have to worry about inserting a paper message with a specific side facing in a specific direction. The scanner 12, 360 is able to capture all of the content from the front and back surfaces of the page in a single pass. While single-sided scanners could be used, doing so would increase the chances of a user inserting a page with the wrong side facing the scanning sensor.

In a preferred embodiment instructions executed by the scanner 12, 360 and computer processor 20, 370 process scan images to crop blank space from around scan images. The scan images are also deskewed so as to have a predominantly rectangular orientation and be more pleasant to view when attached to electronic messages. Blank pages and blank scans are also removed.

In a preferred embodiment the scanner 12, 360 contains a paper sensor that is used to trigger page feeding and scanning.

In a preferred embodiment the opening 310 for feeding message templates and replies is equipped with a paper guide to ensure that inserted message pages are correctly oriented and directed into the scanner. The position and size of the opening 310 and paper guide ensure that inserted pages trigger the scanner's paper sensor and initiate the paper feed rollers. Whenever a message is fed into the outbound opening 310, paper scanning and feeding starts automatically.

In a preferred embodiment a small delay, between 100 and 5000 milliseconds, gives users time to fully insert their page into the opening before the automatic feeding and scanning begins.

In a preferred embodiment the front of the housing 340 of the device opens for easy access to change and reload physical media.

In a preferred embodiment inbound messages dispense through one opening 320 and outbound messages are inserted into a different opening 310 in the surface of the device. The inbound and outbound openings can also be co-located such that there is only a single opening and less opportunity for confusion about which opening should be used for sending messages. In a preferred embodiment the message openings are located on the front surface of the device; but, inbound 320 and outbound 310 openings could be located on the same or different surfaces, and on any surface of the device.

In a preferred embodiment outbound messages are expelled into a tray 330 after they have been scanned.

In a preferred embodiment the device 10 contains a modem, hot-spot, interface card, or similar device for connecting to wireless Internet service. Other ways of connecting to a network are also possible including but not limited to: devices supporting 1G, 2G, 3G, 4G, 5G, or other wireless internet connection services, wireless telephone-based connection services, wireless or wired network bridges for connecting to existing facility networks, Ethernet connections, DSL modems, Cable modems, and telephone line modems.

In a preferred embodiment devices are configured at manufacture to connect to their corresponding inbound 120 and outbound 110 mailboxes on a remote message server 100. Devices do not need to be configured with user specific information. When a user 6A joins a service they receive access to a device 10 and are issued an electronic address 130A. The service associates the user's electronic address 130A with the mailbox 120 of the device 10 on a remote message server 100 such that messages sent to the user's electronic address 130A are automatically forwarded to the correct device mailbox 120. This setup allows changing which users and which electronic addresses are associated with which devices without needing to reconfigure the devices themselves.

In a preferred embodiment the device 10 does not expose any buttons to the user. While it would be obvious to anyone skilled in the art that buttons could be added to control certain functions, in the interest of simplicity all operations are intended to be automatic. For example, the device could be configured to have a button for powering the device on and off, or for sending a message, or even reprinting a message in case a copy is lost. Voice-controlled features can also be incorporated into the devices, systems, and methods of the invention where if needed or desired a user can perform operations using voice commands, such as to send a message to a particular person, or to power on and off the device, or to reprint a message or print a message sent by the user.

In a preferred embodiment the device 10 uses heavier and thicker paper, than is commonly used for receipts, to provide a substantial pleasant feel for handling and writing and to provide more traction to the scanner feed rollers when sending messages. While a variety of paper types may be used, BPA-free simulated parchment roll papers work well. Grammage values should be between 75 and 350.

In a preferred embodiment devices 10 can be monitored and serviced by a remote service provider, without user intervention. The device 10 sends periodic messages to the service provider with information about its status. Status information may include but is not limited to: current network address of the device, version identifiers of the device software components, logs of device operations, results of system health checks, and the length of paper that has been expelled. Service providers may use knowledge of its network address and other settings and identifiers to log into a device remotely using virtual network computing or remote desktop computer tools. Virtual network computing server software runs on the device to enable remote service providers to log into and control the device processor and associated computational components. Example tool titles include but are not limited to: Remote Desktop Connection, RealVNC, TightVNC and GoToMyPC. Persons skilled in the art will recognize that there are many such tools available and suitable for this purpose.

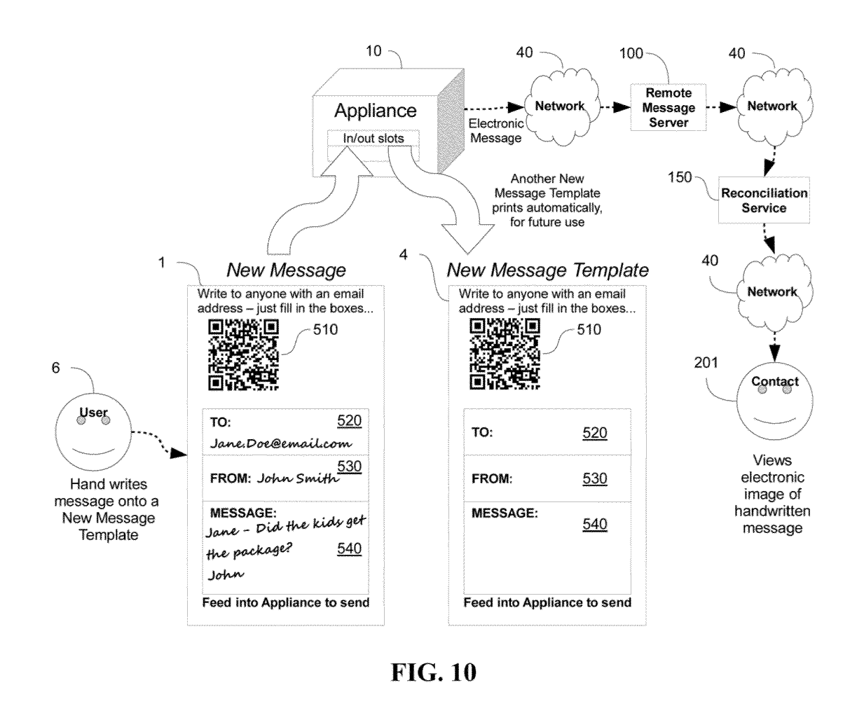

FIG. 10 shows exemplary embodiments of new messages and new message templates according to the invention. A new message template 4 may print from an output slot of the device 10 when the device 10 starts up. The new message template 4 includes a machine readable barcode 510, as well as various fields such as a boxes for filling the contact's 201 email address (“TO:” field) 520, the user's name (“FROM:” field) 530, and a message (“MESSAGE:” field) 540. The user 6 then handwrites the email address in the “TO:” field 520, their name in the “FROM:” field 530, and the message in the “MESSAGE:” field 540 to create a new message 1. The new message 1 is then fed into an input slot of the device 10. When the new message 1 is sent, an additional new message template 4 may print from an output slot of the device 10.

As further shown in FIG. 10, in an exemplary embodiment according to the invention, when a new message is sent, it gets transmitted through a communications network 40 as an electronic message. The message reaches the remote message server 100 which routes it back through a network 40. The message then reaches the reconciliation service 150, which routes it back to a network 40 so that it may reach a contact 201. In embodiments, other intermediate destinations for the message being sent between the sender and the contact 201 are also possible.

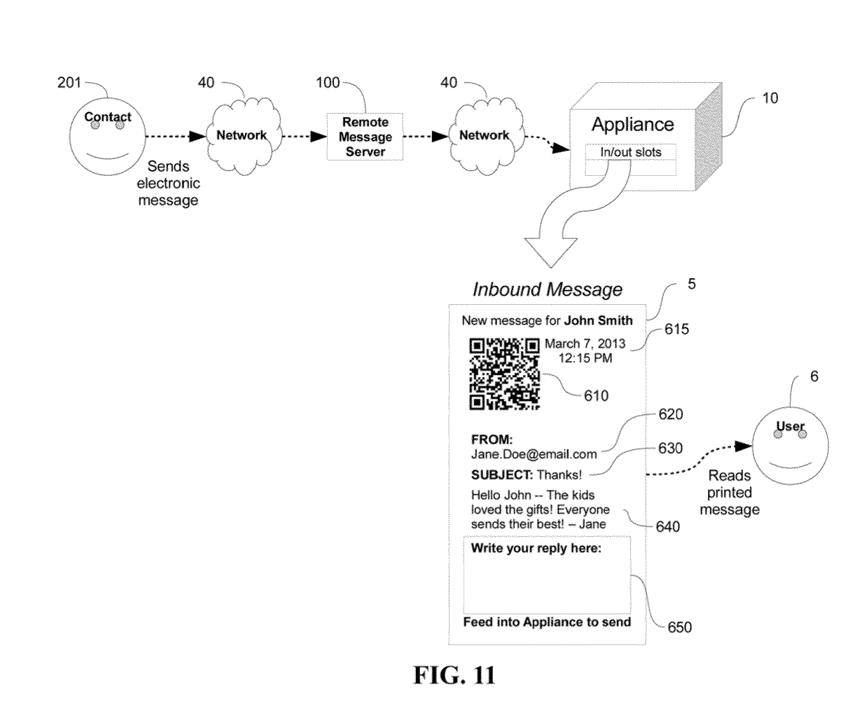

As shown in FIG. 11, in an exemplary embodiment according to the invention, when a contact 201 sends an electronic message, it gets transmitted through a network 40. The message then reaches the remote message server 100, which routes it back to a network 40 where it reaches the communications device 10. The communications device 10 then prints out an inbound message 5 based on the electronic message through an output slot on the device 10. The inbound message 5 includes a machine readable barcode 610, the date which the inbound message was received 615 as well as the electronic address 620 of the contact 201 (“FROM field), a “SUBJECT” field 630, message field 640, and a field for writing a reply 650.

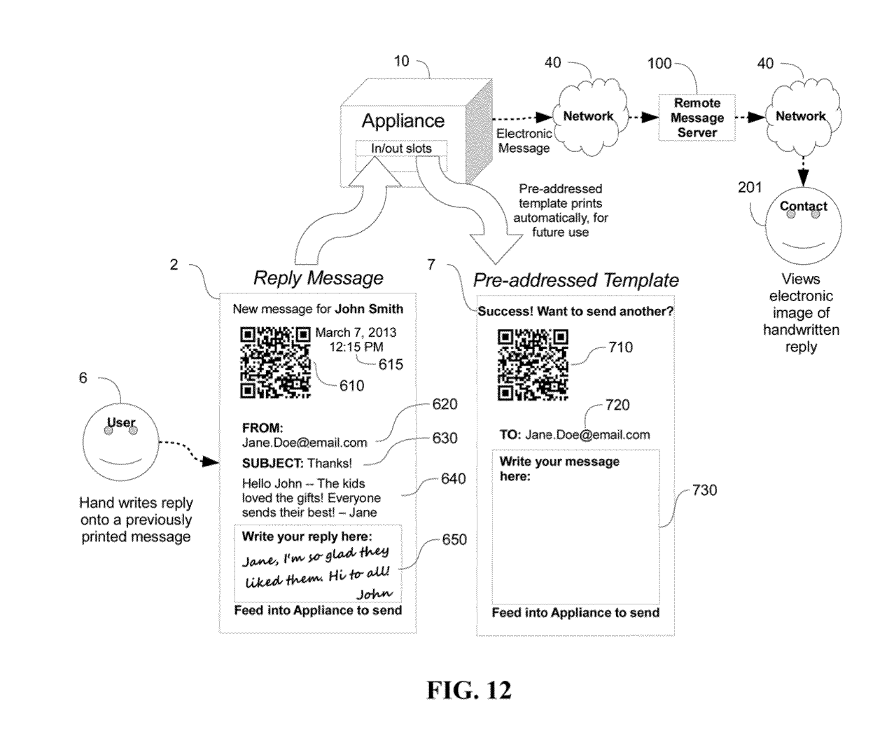

FIG. 12 shows, as an exemplary embodiment according to the invention, a reply message 2 in which a user 6 has written their reply in the reply field 650. The user 6 feeds the reply message 2 into the communications device 10, which transmits an electronic message through the network 40, through the remote message server 100, through the network 40, to a contact 201. The communications device may also print out a pre-addressed template 7. The pre-addressed template has a machine readable barcode 710, a pre-addressed electronic address in the “TO:” field 720, and a message field 730 for writing a message.

In a preferred embodiment electronic messages are emails, but person's skilled in the art will recognize that other types of messages could be exchanged as well including but not limited to SMS text messages, facsimiles, Tweets, and posts and feeds from social media sites (e.g. FACEBOOK) and internet forums and message boards. The format of message data may be that which is appropriate for subsequent retrieval by a receiver by way of a number of different ways, including but not limited to: an email client, a web browser, a web client, a smartphone device, a tablet device, a computer device, a database management system, a specified directory, or the like.

Computer devices for sending and receiving messages by contacts to users of the device 10 will run on one or more computer network protocols, including but not limited to: TCP, UDP, ICMP, HTTP, POP3, FTP, IMAP, SMPT, HTTPS, and WAP. TCP/IP is a fundamental protocol used for packet-based network communications on local area networks, wide area networks, and global telecommunications networks such as the Internet. UDP (User Datagram Protocol) is an alternative “connectionless” communications protocol that runs above IP (Internet Protocol). UDP lacks the error correction and receipt acknowledgment features of connection-based protocols such as TCP. SMPT is a TCP/IP protocol used by electronic mail servers for sending and receiving entails and uses TCP port 25. SMPT is also typically used by computer device users to send email messages to a mail server, while POP3 and IMAP are protocols used for retrieving email messages from a mail server. Computer devices that are the object of a delivered message, in one embodiment, are identified by a unique or temporarily unique IP (Internet Protocol) address, typically in the form A.B.C.D, where each of A, B, C and D represent the Class A, Class B, Class C and Class D sub-networks and each has a value between 0 and 255.

In various embodiments, the electronic destination for outbound message content may be a web server, an email server, a directory location, a database, a storage network, or the like.

In a preferred embodiment the device evaluates received electronic messages to identify those containing or representing special administrative commands, such as to trigger a software update or to restart the device.

In a preferred embodiment the machine readable barcode 510, 610, 710 encoded with destination and origination addresses is a QR Code. QR codes can be printed and decoded from any orientation. They also have advantageous data density and error correction characteristics. Any linear or 2D barcode or symbolic encoding scheme could also be used, including but not limited to the types: U.P.C, Code 1, Code 16K, Code 49, Code 39, Code 93, Code 128, Codablock, DUN 14, FAN 2, EAN 5, FAN-8, EAN-13, GSI-128, GTIN-12, GSI-DataBar, ITF-14, Aztec Code, Data Matrix, EZcode, MaxiCode, PDF417, ShotCode, SuperCode and High Capacity Color Barcode.

In a preferred embodiment instructions 22 executed by the scanner 12, 360 and computer processor 20, 370 use the presence and location of the barcode 510, 610, 710, relative to the boundaries of the scanned images, to identify the side and orientation of each scanned image. Each scanned image is then rotated, as required, so that the images appear right-side-up when viewed in an electronic message.

In a preferred embodiment the ZXing (http://code.google.com/p/zxing) software library is used to encode, identify, locate, and decode barcodes 510, 610, 710.

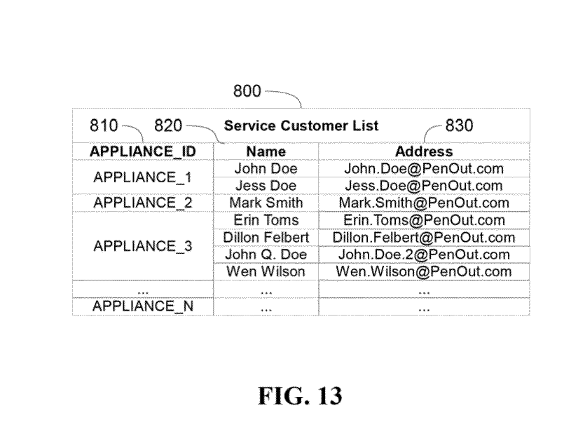

In a preferred embodiment the reconciliation service 150 keeps a database of device ID's, user names, and electronic addresses. When a reconciliation request comes in, for example when a user initiates a message using a new message template, the service looks up which users are associated with the device originating the request to help determine which user sent the message and thus which electronic address to use when resending the message content. FIG. 13 shows an exemplary embodiment of a service customer list 800 used by a reconciliation service 150 that includes the APPLIANCE_ID 810 and associated users 820 and their electronic addresses 830.

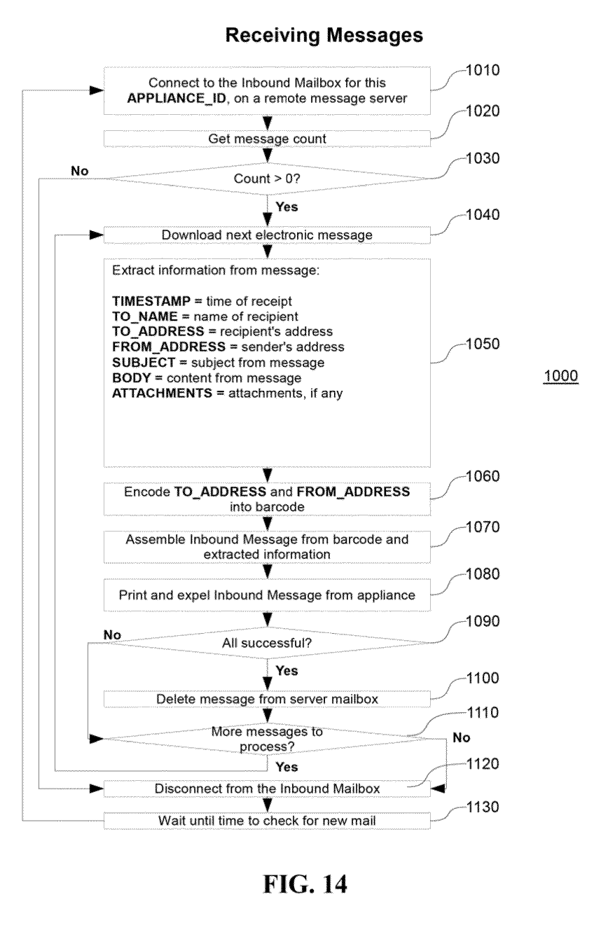

FIG. 14 shows an embodiment of a process for receiving messages 1000 according to the invention. The device 10 first connects to an inbound mailbox 120 for an APPLIANCE_ID, on a remote message server 100, step 1010. The device 10 then obtains a message count, step 1020. After this a decision step 1030 is reached, concerning whether the count is greater than zero. If the count is greater than zero, the device downloads the next electronic message from the remote message server 100, step 1040. After this the device extracts information from the message including a TIMESTAMP (the time of receipt), TO_NAME (name of recipient), TO_ADDRESS (recipient's address), FROM_ADDRESS (sender's address), SUBJECT (subject from message), BODY (content from message), and ATTACHMENTS, step 1050. After extraction, the device encodes the TO_ADDRESS and FROM_ADDRESS into a machine readable bar code, step 1060, and then assembles an inbound message from the barcode and extracted information, step 1070. After assembly, the device prints and expels inbound message 5 from the device 10, step 1080, after which the process 1000 reaches another decision step 1090 which checks whether steps 1040-1080 were successful. If successful, the device 10 deletes the electronic message from the remote message server 100, step 1100, after which the process 1000 reaches another decision step 1110; if not successful, the process 1000 reaches this decision step 1110 directly. Decision step 1110 checks whether there are more messages to process; if yes, process 1000 returns to downloading step 1040, if no, the device 10 disconnects from the Inbound Mailbox 120 on the remote message server 100, step 1120. The device 10 then waits until the next time to check new mail, step 1130, after which it returns to connection step 1010.

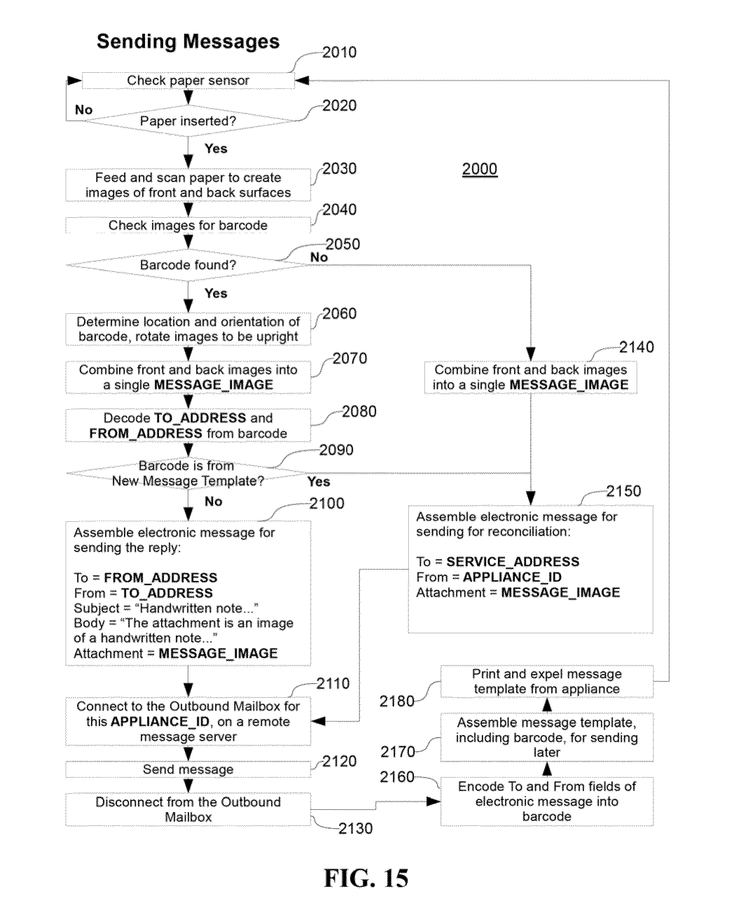

FIG. 15 shows an embodiment of a process for sending messages 2000 according to the invention. The process 2000 begins with the device 10 checking the paper sensor, step 2010. The paper sensor determines a decision step to determine whether a paper message is inserted, step 2020. If the paper is inserted, the device feeds and scans the message to create images of the front and back surfaces, step 2030. The device then checks the scanned images for a barcode, step 2040, which leads to a decision step, step 2050, in which the device 10 determines whether the barcode is found. If the barcode is not found, the device 10 combines front and back images into a single MESSAGE_IMAGE, 2140. If the barcode is found, the device 10 determines the location and orientation of the barcode, and rotates images to be upright, step 2060. The device 10 then combines front and back images into a single MESSAGE_IMAGE, step 2070, and decodes the TO_ADDRESS and FROM_ADDRESS from the barcode, step 2080. The process for sending messages 2000 then leads to a decision step 2090, for determining whether the bar code is from a New Message Template 4. If the barcode is from a New Message Template, 4, the device 10 assembles an electronic message for sending for reconciliation, step 2150, wherein the: “To” field is the electronic address of the reconciliation service (SERVICE_ADDRESS), the “From” field is the device identified (APPLIANCE_ID), and an attachment is the message image (MESSAGE_IMAGE). The assembly step 2150 may assemble electronic messages after the decision step 2090 or the combining step 2140. If the barcode is not from a New Message Template 4, the device assembles an electronic message for sending the reply, wherein the “To” field is the FROM_ADDRESS, the “From” field is the “TO_ADDRESS”, the “Subject” is a handwritten note, a “Body” field, and an attachment which is a message image (MESSAGE_IMAGE). After an electronic image is assembled in either step 2100 or step 2150, the device 10 connects to the Outbound Mailbox 110 for the APPLIANCE_ID of the device 10 on a remote message server 100, step 2110. The device 10 then sends an electronic message, step 2120, and then disconnects from the Outbound Mailbox 110, step 2130. After sending a message, the device 10 encodes “To” and “From” fields of the electronic message into machine readable barcode, step 2160, assembles a message template, including barcode, for sending later, step 2170, and then prints and expels a message template 4, step 2180, after which the process 2000 returns to step 2010.

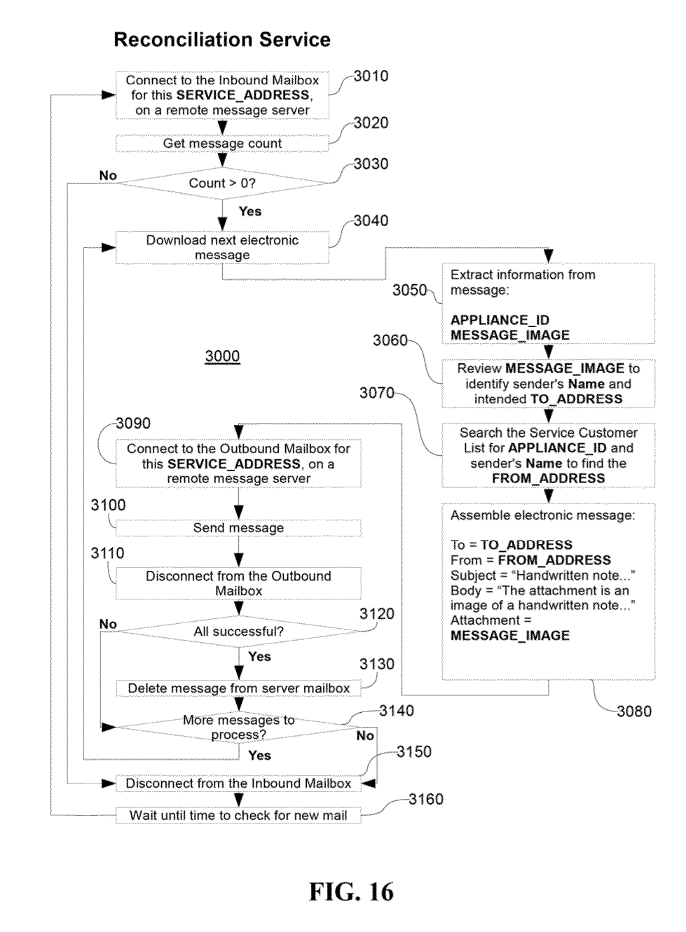

FIG. 16 shows an exemplary embodiment of a Reconciliation Service process 3000 according to the invention. The process 3000 begins with the reconciliation service 150 connected to the Inbound Mailbox 120S through the Electronic Address for Service 130S on a Remote Message Server 100, step 3010. After connecting, the reconciliation service 150 obtains a message count, step 3020. After obtaining a message count, the reconciliation service 150 determines whether there are one or more messages, step 3030. If the message count is greater than zero, the reconciliation service 150 downloads the next electronic message, step 3040, after which it extracts information from the message, including the APPLIANCE_ID and MESSAGE_IMAGE, step 3050. The service 150 then reviews the MESSAGE_IMAGE to identify sender's name and intended TO_ADDRESS, step 3060. The service 150 then searches the Service Customer List 800 for the APPLIANCE_ID and sender's Name to find the FROM_ADDRESS, step 3070. The service then assembles an electronic message wherein the “To” field is designated the TO_ADDRESS, the “From” field is designated the “FROM_ADDRESS”, the “Subject” is a handwritten note, a “Body” field, and an attachment which is the MESSAGE_IMAGE, step 3080. The service 150 then connects to the Outbound Mailbox 1100S for the service address 130S through the network 40 on a remote message server 100, step 3090. The service then sends the electronic message, step 3100 and disconnects from the Outbound Mailbox 110S, step 3110. The service then checks to see if the previous steps were successful, step 3120. If successful, messages are deleted from the server mailbox, step 3130, after which a decision step is reached, step 3140; if not successful, this decision step 3140 is reached directly. The decision step 3140 determines whether there are more messages to process. If there are more messages to process, the process 3000 returns to the downloading step, step 3040; if not, the service disconnects from the Inbound Mailbox 120S, step 3150, and then waits for the next time to check for new mail, step 3160, after which it returns to the connection step 3010.

In a preferred embodiment, electronic image representations of message content (MESSAGE_IMAGE) are embedded, attached, linked, or otherwise associated with electronic messages as widely-used image formats including but not limited to: JPEG, Exif, TIFF, RAW, GIF, BMP, PNG, PPM, PGM, PBM, PNM, PFM, PAM, WEBP, RGBE, IFF-RGFX, CGM, Gerber Format, SVG, MPO, PNS, JPS, EPS, PDF, PostScript, PICT, SWF, XAML, WMF, and EMF.

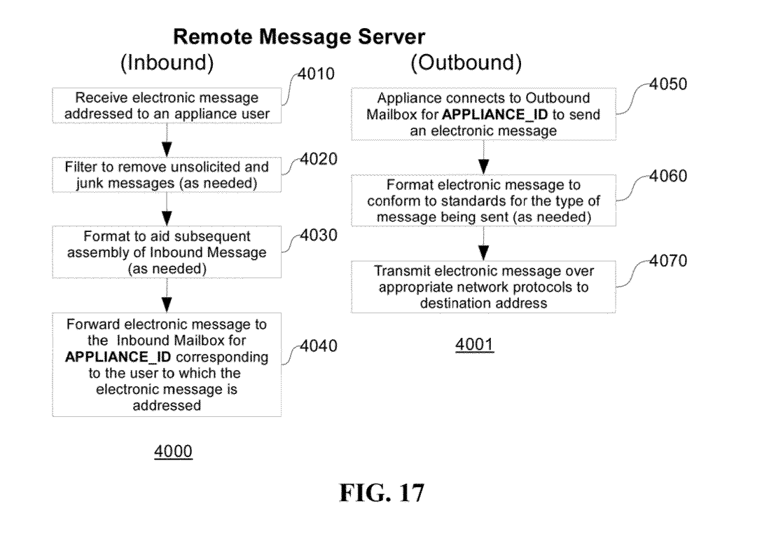

FIG. 17 show exemplary embodiments of inbound 4000 and outbound 4001 processes for a remote message server 100 according to the invention. The inbound process 4000 begins with the server 100 receiving an electronic message addressed to a device user, step 4010. The server 100 then filters the message to determine whether it is an unsolicited or junk message, and if needed, removes it, step 4020. The electronic message is then formatted to aid subsequent assembly of an inbound message, as needed, step 4030. The server 100 then forwards the electronic message to the Inbound Mailbox 120 for the particular APPLIANCE_ID corresponding to the user 6 to which the electronic message is addressed, step 4040.

For the outbound process 4001, the server 100 connects to the Outbound Mailbox 110 for the device's particular Appliance ID to send an electronic message, step 4050. The server 100 formats the electronic message to conform to standards for the type of message being sent, as needed, step 4060. The electronic message is then transmitted over appropriate network protocols to the destination address corresponding to a contact 201, step 4070.

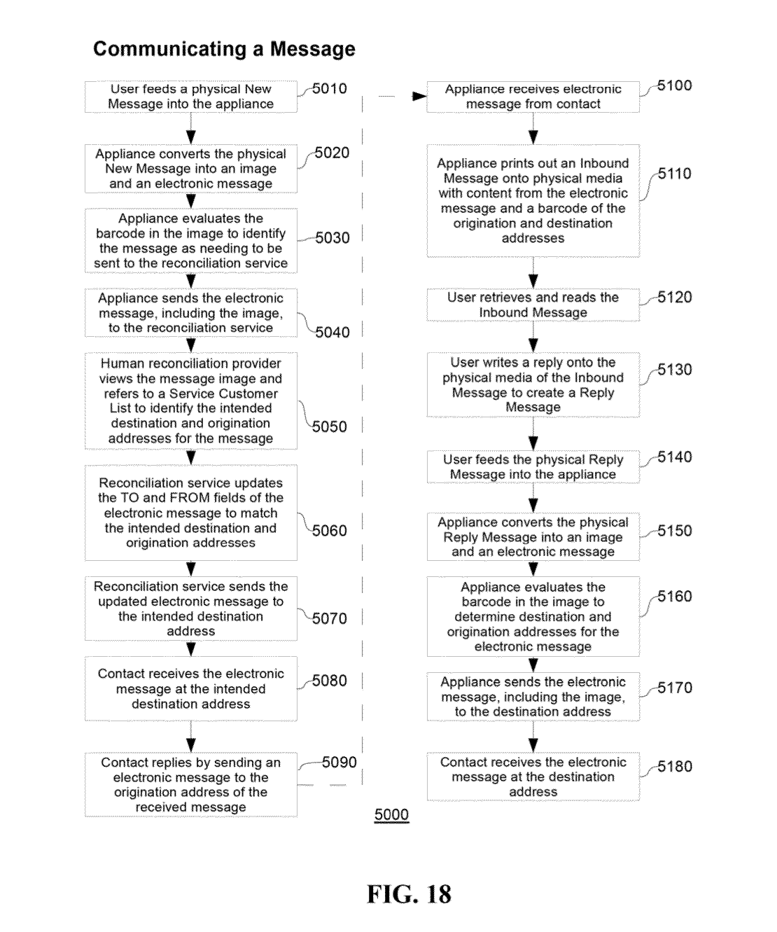

FIG. 18 shows an embodiment of a process for communicating a message according to the invention. Steps in process 5000 encompass steps in processes for receiving messages, processes for sending messages, and reconciliation service processes, that are described in more detail in reference to FIG. 14, FIG. 15, and FIG. 16, respectively. The process 5000 begins with a user 6 feeding a physical New Message 1 into an appliance 10, step 5010. The components and processes of appliance 10, including scanner 12 and processor 20, converts the message 1 into an electronic image and an electronic message, step 5020. Appliance 10 evaluates the barcode 510 captured in the electronic image and determines that the image is of a New Message 1 and therefore needs to be sent to the reconciliation service 150, step 5030. Appliance 10 then sends the electronic message, including the electronic image, to the reconciliation service, step 5040. A human reconciliation provider views the electronic image to find the user's entries for intended destination address, as handwritten into field 520 of New Message 1, and their full name, as handwritten into field 530 of New Message 1. The human reconciliation provider then looks up the user's electronic address, from their full name and from the identifier of the appliance 10 that sent the message, in the Service Customer List 800. The human reconciliation provider identifies the user's electronic address as the intended origination address, and along with the already identified intended destination address, completes step 5050. The reconciliation service 150 then updates the TO and FROM fields of the electronic message to match the intended destination and origination addresses, as identified by the human reconciliation provider, step 5060. Next, the reconciliation service 150 sends the updated electronic message on to the intended destination address, step 5070. A contact 201 of the user 6 receives the electronic message, step 5080. Contact 201 then replies by sending an electronic message to the origination address of the received message, step 5090. Contact 201 does not need to input, delete, or alter the address information and their reply message routes directly back to the electronic address of the user 6, without passing through the reconciliation service 150 or requiring input from another human.

Alternatively or in addition, as indicated by the dashed connecting line between steps 5090 and 5100 in FIG. 18, the appliance 10 receives an electronic message from contact 201, step 5100. Appliance 10 automatically identifies the origination and destination addresses from the incoming electronic message and prints out a physical Inbound Message 5 including content from the electronic message and a barcode 610 of the origination and destination addresses, step 5110. User 6 retrieves and reads physical Inbound Message 5, step 5120. User 6 writes a reply onto the physical Inbound Message 5, thereby creating the physical Reply Message 2, step 5130. User 6 feeds Reply Message 2 into appliance 10, step 5140. The components and processes of appliance 10, including scanner 12 and processor 20, converts the message 2 into an electronic image and an electronic message, step 5150. Appliance 10 evaluates the barcode 610 captured in the electronic image to determine the origination and destination addresses for the electronic message, step 5160. Appliance 10 then sends the electronic message, including the electronic image, to the destination address, step 5070. Contact 201 then receives the electronic message in step 5080 to complete process 5000.

The processes of the invention, examples of which are shown in FIGS. 14-18, may be carried out by computer-executable instructions 22 as identified in FIG. 1. The computer-executable instructions 22 of the device 10 may be organized into routines, subroutines, procedures, objects, methods, functions, or any other organization of computer-executable instructions that is known or becomes known to a skilled artisan in light of this disclosure, where the computer-executable instructions are configured to direct a device 10 to perform one or more of the specified tasks of the invention. The computer-executable instructions can be stored contiguously or non-contiguously. Further, the memory 28 may be a Random Access Memory (“RAM”) or Read Only Memory (“ROM”), and the storage 26 may be any suitable storage device (hard drive or disk drive) or storage medium (CD-ROM).

The communications device, system, and method according to the invention enable electronic communication entirely through a physical interface, without the need for typing or using a computer. The communications device, system, and method employ automated processes so that no user action is required for checking or printing new incoming messages. The invention uses proven, reliable technology (machine readable barcode) for encoding destination and origination addresses of messages. The invention requires minimal user action for sending a message, wherein an outbound message is simply inserted into an input for the device, and feeding, scanning, processing, and transmitting of the message in the form of an electronic message is automatic. The invention uses existing, proven technology for sending and receiving electronic messages and converting them to and from printed form. The invention requires no knowledge of communications protocols or systems and there are no buttons or displays that must be learned by a user, those providing a high degree of usability and minimal maintenance. When configured to exchange email, the invention provides near universal accessibility. The invention provides a communications device, system, and method with a high degree of usability for those lacking technical knowledge.

The present invention has been described with reference to particular embodiments having various features. It will be apparent to those skilled in the art that various modifications and variations can be made in the practice of the present invention without departing from the scope or spirit of the invention. One skilled in the art will recognize that other variations may be substituted for those described herein that fall within the scope and spirit of the invention. For example, variations such as the sending and receiving of other forms of communication, such as voicemails, pictures, documents, video, and faxes, through the devices, systems, and methods described herein may also fall within the scope of the invention. Other embodiments of the invention will be apparent to those skilled in the art from consideration of the specification and practice of the invention. The description of the invention provided is merely exemplary in nature and, thus, variations that do not depart from the essence of the invention are intended to be within the scope of the invention. It is further noted that each patent or published application referenced in the text of this specification is incorporated by reference herein each in its entirety.

1. A communication device comprising:
a first processing module for identifying an origination and destination address from an incoming message;
a printer operably configured to print the origination and destination addresses as one or more barcodes, with content from the incoming message, onto physical media;
an imaging module operably configured for converting an outgoing message disposed on the physical media with the one or more barcodes to an electronic image;
a second processing module for reading and using the one or more barcodes to determine a destination address for the outgoing message; and
a communications module operably configured for delivering the outgoing message to the destination address.

2. The communications device of claim 1, wherein the imaging module is operably configured for inputting the physical media annotated with message content.

3. The communications device of claim 2, wherein the imaging module is operably configured for constraining size and orientation of the physical media.

4. The communications device of claim 1, wherein the printer is operably configured to print automatically in response to the incoming message.

5. The communications device of claim 1, wherein the outgoing message is routed to a destination address associated with a reconciliation service comprising a human capable of processing electronic messages for delivery to another address.

6. The communications device of claim 5, wherein the reconciliation service is capable of determining the destination address from the electronic image.

7. The communications device of claim 1, wherein the outgoing message comprises electronic image representations of message content embedded, attached, linked, or associated with the outgoing message.

8. The communications device of claim 1, further comprising executable instructions embedded in a computer readable medium for automating one or more operations performed by the imaging module, the communications module, the first or second processing module, or the printer.

9. The communications device of claim 1, wherein the communications module is operably configured with a network interface for connecting to an electronic network and for transmitting and receiving the outgoing and the incoming messages to and from remote computing devices.

10. A communications system comprising:
a. at least one first device having a communications address unique to the first device, wherein the first device is operably configured for converting a first message disposed on physical media to an image and operably configured for sending the image over an electronic network to a second device;
b. at least one second device operably configured for a human to interpret a destination address from the image and to enable sending of the image to the destination address from the second device while appearing to be from the communications address associated with a user of the first device; and
c. at least one third device operably configured for receiving the image from the second device and for sending a reply message to the first device without sending the reply message to the human.

11. The communications system of claim 10, wherein the at least one first, second, and third devices are disposed remote from one another.

12. The communications system of claim 10, wherein the destination address is in operable communication with a device capable of receiving an email or SMS text message.

13. The communications system of claim 10, wherein the destination address is not an address for a fax machine.

14. A method of communicating a message comprising:
automatically identifying an origination and destination address from an incoming message;
printing the origination and destination addresses as one or more barcodes, with content from the incoming message, onto physical media;
converting an outgoing message disposed on the physical media with the one or more barcodes to an electronic image;
reading and using the one or more barcodes to determine a destination address for the outgoing message; and
delivering the outgoing message to the destination address.

15. The method of claim 14 comprising sending the outgoing message to the destination address without a user inputting the destination address.

16. The method of claim 15, wherein the destination address is in operable communication with a device capable of receiving an email or SMS text message.

17. The method of claim 14, wherein the destination address is not an address for a fax machine.
